(19) United States
(12) Patent Application Publication
(10) Pub. No.: US 2015/0284104 A1
(43) Pub. Date: Oct. 8, 2015

(54) Rotatable fairing and engine inlet system for high-speed aircraft

(71) Applicant: PENG ZHAO, GAMBRILLS, MD (US)

(72) Inventor: PENG ZHAO, GAMBRILLS, MD (US)

(21) Appl. No.: 14/246,021

(22) Filed: Apr. 4, 2014

(51) Int. Cl. B64D 33/02; B64D 29/02; F02C 7/055; F02C 3/10; F02C 7/045

(52) U.S. Cl. CPC B64D 33/02; F02C 3/10; F02C 7/045; F02C 7/055; B64D 29/02; B64D 2033/0273; B64D 2033/026; B64D 2033/0226

(57) ABSTRACT

A rotatable fairing and an engine inlet for a high cruise speed aircraft are introduced. The fairing has a generally semi-cylindrical shape with tapering at either end. The fairing is movably attached to the wing and the circumference of the inlet to allow for rotational movement. The front portion of the fairing is partially outside of the inlet and forms a piece of the airplane wing and the back portion resides inside the inlet. The fairing can be rotated along its longitudinal axis to one of two states, allowing air to flow into the main engine inlet either from above or below the wing. A second embodiment of the invention adds to the fairing structure an actual inlet portion, which can also be rotated to either above or below the wing and accommodate boundary layer diversion features and movable ramps needed for high supersonic speeds.

### TECHNICAL FIELD

The present invention belongs in the broad field of aircraft design. On a more specific level, it relates to the design of engine inlets for high-speed aircrafts powered by gas turbine engines, and methods of integration of the inlet with the aircraft's wing, to prevent or even eliminate the ingestion of foreign object debris into the engine core.

### BACKGROUND ART

The gas turbine engine is used to power most of today's aircrafts designed for military and commercial use, and it is one of the most important components onboard. The engine provides the necessary force pushing the plane forward, allowing the wing to interact with the atmosphere in order to generate aerodynamic lift to keep the vehicle airborne. Modern gas turbine turbofan engine operates by sucking in huge amounts of air with a large fan and blowing it out of the back. A small portion of the air enters a series of axial compressor stages, which pressurizes the air and sends it to the combustor chamber for mixing with fuel, creating a hot and fast-moving stream of air, which then rushes backwards to turn the turbine, transmitting the torque via a shaft to drive the aforementioned compressor responsible for compressing the air in the first hand. Thus, all the major moving components are mutually dependent on one another. For the engine to work properly the air entering the compressor has to be free of foreign object debris.

In aviation jargon, FOD stands for Foreign Object Damage or Foreign Object Debris, which can be anything manmade found on airport ground. Most of the time, they are tiny loose parts from airport equipments, passenger luggage, or other planes. While foreign object debris is most often categorically described as small objects and particles, larger and heavier items are also able to get sucked up off the ground. Because of their size and mass, they can significant damage the engine's nacelle and cowling section. In one rare but documented case, an airplane LD3 cargo container was sucked into the starboard engine of a Japan Airlines 747 while taxing. The container became stuck at the opening of the engine nacelle, causing damage to the nacelle as well as the fan blades and spinner hub, not to mention the economic impact of flight cancellation and the cost of rescheduling the passengers onto another flight. In more tragic circumstances, even humans have been accidentally ingested into running engines. There has also been at least one documented incident in which a ground crew was sucked into a running engine and killed while performing maintenance work. The issue of engine capable of ingesting things large and small as we now know is well known in the aviation industry, costing airlines and operators millions in lost revenue each year while posing a safety risk to both passengers and crews.

The danger of foreign object damage to important engine components is the highest not when the plane is flying at cruising altitude but when the plane is operating on the ground. As long as the plane is in motion on its own power, the engine must also be running to provide forward force. Even when an airplane is taxing around the airport, the engine is running at significant thrust levels. When a plane is accelerating on the runway for takeoff, the engine is usually running at its highest thrust levels. At an airport, foreign object debris on the ground could pose significant risk to aircrafts, which can ingest them into the engine, causing damage to key components, even failure. Sometimes, a plane's landing gear could even make ingestion easier by kicking up ground debris into the direction of the engine. This could be catastrophic if debris is ingested as the plane is on its takeoff run, during which the engine is operating at high power settings. Planes with engines mounted on the back of the wing, such as those that fly at high transonic to supersonic speeds are particularly vulnerable to this problem if the engine is mounted near the main landing gear unit and underneath the wing, such as the Concorde, the Tu-144, and the concept planes like Boeing 2707 and the Sonic Cruiser.

For decades since the dawn of jet aviation, the vast majority of commercial aircrafts have been designed to operate in the subsonic speed regime. Currently however, there is a renewed effort to pursue technologies that could lead to the development of future high transonic to supersonic passenger aircrafts. The U.S. government and industry partners have teamed up in an effort to develop a high-speed transport for entry into commercial service in the middle of this century or earlier. Initial work is on a design that minimizes sonic boom disturbance, with other aspects still to come. Because most high transonic and supersonic designs call for an engine mounted in the rear portion of the generally delta-shaped wing, there is a continued need in the field to address and resolve the problem of foreign object debris ingestion. It's the object of this invention to reduce or even eliminate FOD using a novel approach with minimal impact on the aerodynamic performance of the aircraft and engine. It is also determined that the unique fairing system would also reduce the amount of engine fan noise entering the cabin, providing a quiet atmosphere for passengers.

Numerous methods of preventing foreign debris ingestion have been disclosed in the past. One prevailing solution involves installing blocker doors near the opening of the inlet or in other areas on the aircraft to deflect debris kicked up by the landing gear toward a direction away from the engine intake. While doors may help block out debris, one drawback is that direct airflow into the engine is disrupted. In many cases, air will then have to take an alternative, generally more torturous path to the engine, either around the blocker door, or through another less optimal side inlet opening. Besides hindering airflow, blocker doors and shield plates also add to the weight of the airplane and their temporary benefit is unfortunately offset by the drag generated during the time they are deployed such as takeoffs and landings. There is also the chance that the shields fails to block all the debris particles. An aircraft that employs the technique described above is the MIG-29. There is a hinged door that swings down to close the inlet when the plane is taking off and landing to block ground debris. A series of vanes on the upper surface of the wing root extension are then opened to deliver air into the engine inlet. Because the inlet doesn't face perpendicularly to the flow, air has to take a slight turn at the vane entrance, not to mention the reduction in mass flow that could hamper engine performance.

Other approaches have also been proposed and utilized. In one design scheme, the complete engine unit is placed entirely above the wing. Such an arrangement does prevent foreign object damage and also block engine noise from reaching ground level, but it also introduces other areas of concern. Placing the engine above the wing means that more noise now reaches the passenger cabin rather than down below the plane because the engine inlet and nozzle are right next to the fuselage. The aircraft cabin is directly exposed to the noise from the engine's front most fan blades as well as the exhaust's turbulent mixing. The need to protect residential communities from aviation noise diminishes as plane climbs higher into the sky. At high altitudes, the main target of engine noise is the aircraft cabin and the ears of passengers and crewmembers. Engine mounted above the wing pose directly noise disturbance to the aircraft cabin. Thus, it would be highly beneficial if there were inlet designs that can shield engine noise and provide passengers and crew a better flying experience. Additionally, the engine nacelle above the wing could interfere with the aerodynamics of upper surface of the wing. Because of its high mounting position, it also poses a major inconvenience for ground personnel who sometimes may need to open the engine cowling for between-flight checks or other technical reasons. To do that, they will need special equipment to hoist them up to the same elevation as the mounted engine to perform their duties. The job becomes even more cumbersome if an engine has to be replaced.

In recognition of the impact of foreign object debris, the drawbacks and deficiencies exhibited by prior solutions and therefore the need for an improved method and apparatus that aims to eliminate FOD and to ensure the safety of ground crews working around airplanes without introducing the numerous flaws of current methods that have been so far described, an improved solution is desirable. The present invention utilizes a rotary inlet fairing within the inlet, along with seamless integration with the wing, to reduce and or even eliminate the ingestion of ground debris during takeoff, landing, taxiing, while providing numerous identified and or undiscovered benefits to the operation of the aircraft.

### SUMMARY OF INVENTION

A new and more effective method of preventing or eliminating the ingestion of foreign debris is provided in recognition of the risk this problem poses to the safety of flight and critical engine components. The disclosure focuses on providing a fairing structural member, integration techniques and method of operation for the purpose of preventing foreign object debris from being ingested into the engine core. Another object of the invention is to improve aircraft aerodynamic performance and reduce the impact of engine noise on both passengers and residential neighborhoods. The embodiments disclosed in the invention dictate the inlet and the fairing member to be of a certain shape and be closely integrated with the airplane wing in order to achieve the stated objectives. It's also the goal of this invention to provide a novel approach that eliminates the drawbacks and limitations of previous solutions in the field. Furthermore, the device helps protect ground crews and those working close to the aircraft, especially when the plane's engines are running. In addition to preventing foreign object debris, the apparatus has the potential of enhancing the aerodynamic performance of the airplane during the takeoff and landing phase. During takeoff, landing and taxiing, an airplane is exposed to the risk of foreign object damage. Thus, to avoid the ingestion of foreign object debris, the inlet fairing can be rotated to close the inlet underneath the wing, allowing the engine to only ingest air from above the wing After the plane has reached a certain altitude above ground level, the fairing can be rotated to create an inlet opening below the wing and inlet closure above the wing to ensure optimal aerodynamic performance and as a way of reducing the impact of engine noise on passengers in the interior of the aircraft. The fairing and inlet combination can easily be modified into different shapes to satisfy aerodynamic considerations, and those skilled in the art can recognize that it is possible to modify the invention within its scope to arrive at a final configuration that best suits the performance requirement of the airplane. One possible derivative of the main embodiment of the invention involves attaching the frontal portion of an actual inlet to the fairing to allow for the installation of variable geometry ramps required at higher supersonic speeds. The inlet opening can be rotated to either above the wing to eliminate ground debris. The rate at which air enters the inlet as a result of the ingesting force of the engine fan is generally greater than the rate of airflow past the rear portion of the upper surface of the wing at take off speeds. Thus, the pressure on the rear upper surface of the wing is lower than usual, more lift is generated and lift distribution is improved. There's yet another benefit from utilizing the present invention on an aircraft of the mentioned type. Because the tip of most engine fan spins at transonic to supersonic speed, a tremendous of sound energy is created. After the airplane has become airborne, the fairing device can be rotated to close the upper surface opening of the inlet. The fairing will then act as an impediment between the engine fan and the aircraft cabin, thus stopping the propagation of shock-induced fan noise. Specifically, the present invention will provide a FOD prevention apparatus for a high-speed aircraft, which tends to have a wing plan form that is usually in the shape of the traditional delta configuration and which has the main engine installed near the rear part of the wing. A delta wing plan form is distinguished by its low aspect ratios. Visually speaking, this generally means that the root of the wing is longer than the span of the wing. It's the longitudinal length of high-speed aircrafts that is suited to take fully advantage of the following invention. The engine is understood to mean a single unit comprising of many components, including most prominently a large fan to suck in air, followed by a multi-stage compressor, a combustor and a series of turbine stages. A cylindrically shaped inlet, enclosing the engine and the fairing member, is attached to the wing on symmetric sides about its centerline along the direction of the longitudinal axis of the airplane. Accordingly, the inlet should be longer than the engine unit, which is positioned at the rear of the inlet. Because the engine is situated at the rear of the inlet duct, a significant amount of duct volume exists between the inlet entry and front most portion of the engine. The wings of a high-speed aircraft typically have long chords that are especially tailored to work together with the inlet and fairing system in achieving the present invention's stated goal of preventing foreign debris ingestion. It will be clearly seen that a large percentage of the wing area is ahead of the inlet and that it's in fact the wing that acts as a big shield against debris. The portion of the inlet that contains the fairing member would have a circular cross section to support rotation of the fairing within the inlet. However, the radius of the circular cross section therein need not be constant and can vary in any way from the inlet entry in the direction of the engine face. Obvious to those familiar with the art is the fact that the aforementioned design belongs to the class of boundary layer ingesting inlets. Therefore, a second embodiment of the invention is also provided to give a traditional configuration with means of diverting the boundary layer away from the inlet. As will be seen, the second embodiment also has the benefit of providing space for the installation of movable ramps that are traditionally a part of supersonic inlets.

### BRIEF DESCRIPTION OF DRAWINGS

The accompanying drawings are meant to illustrate the key features of the invention as well as make the detailed explanations clearer. Some of the illustrations are schematically drawn for simplicity, such as those representing parts of an exemplary high-speed aircraft.

FIG. 1 is notional high-speed aircraft employing inlet and fairing system

FIG. 2 is a top-down view of wing layout configured for inlet, engine, and fairing

FIG. 3 is a top-down view of wing with inlet, and engine

FIG. 4 is top-down view of wing with inlet and fairing and engine

FIG. 5 is a sectional view of the first embodiment with fairing above the wing

FIG. 6 is a sectional view of the first embodiment with fairing below the wing

FIG. 7 is a side view of fairing at the half-way point during rotation

FIG. 8 is a frontal view of the fairing at the half-way point during rotation.

FIG. 9 is a sectional view of second embodiment with rotatable inlet over the wing

FIG. 10 is a sectional view of second embodiment with the rotatable inlet below the wing

### DESCRIPTION OF EMBODIMENTS

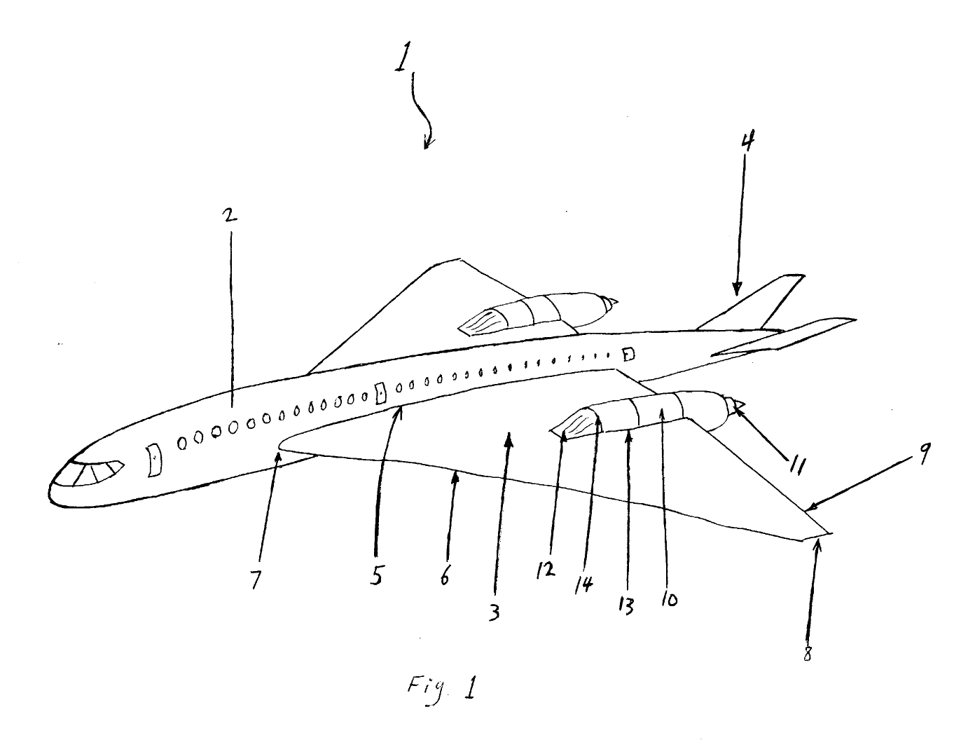

Numerals are used to identify the various components referred to in the description. It was also made for ease of identification that each number uniquely refers to a particular part of the invention and doesn't change from one drawing to another. Firstly, an exemplary high transonic to supersonic airplane employing the invention is depicted in FIG. 1. The airplane 1, shown by the arrow, has a fuselage 2 whose primary role is to carry passengers, crew and cargo, landing gears, avionics and other aircraft-related equipment. The fuselage serves as the backbone of the airplane 1. All the other major components are connected to the fuselage. These include a pair of wings 3 attached to either side of the fuselage 2, a pair or vertical and horizontal stabilizing surfaces 4 are attached at the back of the fuselage 1. FIG. 1 serves to illustrate just one possible configuration of a high transonic to supersonic aircraft and is intended to show how the invention may appear on a typical aircraft. Other high-speed airplane configurations exist in the art, such as placing the horizontal stabilizers ahead of the wing as canards, not shown in the figure.

Due to the airplane's symmetry, descriptions will be given for the left side of airplane. The plane's left side is understood to be the side a passenger would identify as when sitting and facing in the direction of flight. The main wing 3 in FIG. 1 has a typical delta shaped plan form. In the drawing, it can be seen the wings have a line of attachment 5 with airplane 1's fuselage 2 that is nearly as long as its entire length. Another distinguishing feature of high speed wing geometry is that the half span of the wing as measured from the fuselage's center longitudinal axis to either wingtip is relatively short compared to the length of the wing root. These ratios are characteristic of high-speed aircrafts and give the wing a so-called small aspect ratio. The wing has a leading edge portion 6 as shown in FIG. 1. The leading edge 6 is identified as the longest side of the delta wing 3 and it's the part of the wing 3 that encounters the oncoming airflow first. The leading edge 6 starts at the most forward point 7 of line of attachment 5 along fuselage 2 and extends outward to the tip 8 of the wing 3. The wing 3 also has trailing edge 9, which is the shortest of the three sides of wing 3 and is where air from under and over the win rejoins the free stream airflow. Both the leading edge 6 and trailing edge 9 emanates in the direction of the wing tip. The leading edge 6 and the trailing edge 3 also usually employ movable members, not shown, that are deployed outwardly acting as slats and flaps during takeoff and landing.

A fixed cylindrical inlet duct 10 encloses a gas turbine engine 11 and fairing 12 and fixedly occupies a portion of wing 3. FIG. 1 only shows the portions of engine 11 and fairing 12 that are visible externally. Parts of fairing 12 and engine 11 not visible in FIG. 1 will be seen more clearly in subsequent drawings. In FIG. 1, the external structure of the fixed engine inlet 10 and fairing 11 are drawn in their fully installed positions on airplane 1. The top half of the fixed cylindrical inlet 10 rises above the geometric plane of wing 3 and appears as a cylindrical dome structure. The other half, also in a cylindrical dome shape, is below the wing plane and hidden in the figure by wing 3 but will be visible in other figures. In the figure, the fixed inlet duct 10 encloses engine 11 except for its exhaust nozzle 17, which protrudes out from the back of fixed inlet duct 10. The entire fixed inlet 10 containing the engine 11 and partially fairing 12 is fixedly attached to wing 3 of airplane 1 along the line 13, which is also the number to denote the line of attachment symmetrically on the other side of fixed inlet 10. Although the wing 3 doesn't structurally goes through the fixed inlet, the imaginary plane of wing 3 passes exactly through the longitudinal centerline of the fixed inlet duct 10. Inlet duct 10 is attached relative to wing 3 in such a way that one half of the circular inlet opening 14 is above the wing plane, and the other below the wing plane, both having a semi-circular shape. A rotationally linked fairing member 12 occupies one half of the circular opening 14 at any one time, allowing air to flow into inlet 10 through opening from the other half of the circular inlet opening 14, which is either above or below the wing 3. FIG. 1 shows the inlet fairing 12 rotated to close the inlet opening 12 that is above the plane of wing 3, leaving the inlet opening below the wing 3 open for drawing in air into the engine. The internal structure of the inlet 10 and its relationship with the fairing 12 will become clearer in the subsequent drawings.

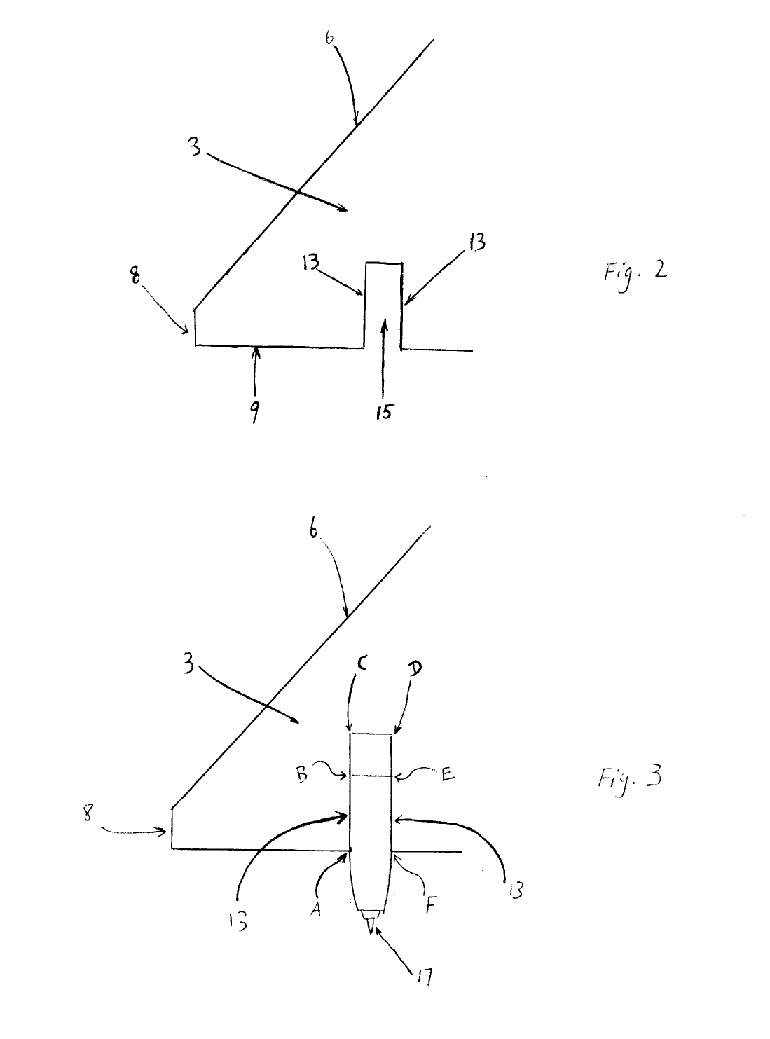

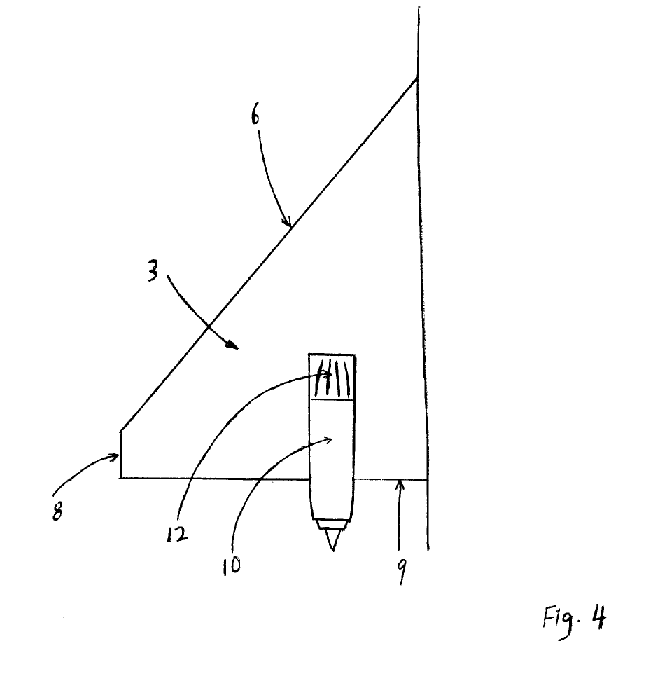

Inlet duct 10 and fairing 12 both have attachments with wing 3 and are shown in their assembled state in FIG. 1 and FIG. 4. Meanwhile, the required amount of space created in the wing for inlet 10 and fairing 12 is denoted in FIG. 2 by 15. Preferably, the wing 3 could be made up of different sections so after assembly, they are arranged in a manner shown in FIG. 2. The space 15 has a markedly rectangular dimension that roughly equals the diametric width and longitudinal length of inlet duct 10. The space 15 where the inlet 10 and fairing 12 are to occupy is illustrated in FIG. 2., a top-down view of the wing 3 of airplane 1 in FIG. 1. The space 15 has boundaries defined by symmetrical lines 13, along which the inlet is attached to the wing, and line 16. It's apparent that space 15 is surrounded on three sides by wing 3. The resulting structural mating of the inlet 10 containing the engine 11 with wing 3 is featured in FIG. 3. The inlet duct 10 is attached to the wing 3 on symmetric sides along a portion of lines 13. The portions of lines 13 where inlet 10 attaches with wing 3 are identified by segment AB and segment EF in FIG. 3. Inlet 10 shelters most of engine 3, except the exit nozzle 17, which extends out from the back opening 18 of the inlet 10. The partial usage by inlet 10 of space 15 leads to there being a rectangular area of opening just forward of the inlet 10's frontal opening 14. The rectangular opening, or aperture is precisely a portion of space 15 not occupied by inlet 10 and is represented by rectangle BCDE, where the length of line BE and CD equals the diameter of the inlet 10, while lines BC and DE denote the rectangle's other pair of symmetrical sides and have identical lengths. As identically depicted in both FIG. 4 and FIG. 1, a rotational fairing member 12 is axially attached to the wing 3 and covering aperture 19 as well as the upper semi-circle half of the circular inlet opening 14. The horizontal dimensions of the portion of fairing 12 that's shown in FIG. 1 and FIG. 4 and on the outside of and forward of inlet opening 14 are identical to that of aperture 19, also denoted as rectangle BCDE. In the present embodiment, such coincidence of dimension is indeed necessary to allow aperture 19 to be closed by fairing member 12.

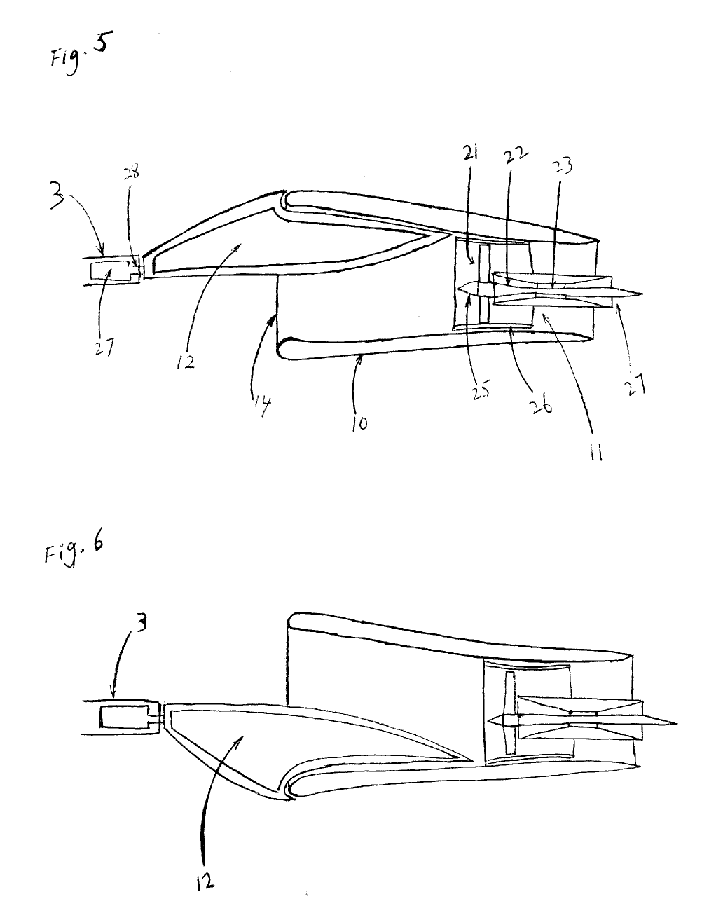

Furthermore, the present embodiment is represented in the so far described figures to include the unique feature that when the fairing 12 is rotated axially, only one half of the circular inlet opening 14 is opened, either above wing 3 or below wing 3. During rotation, the rotational fairing member 12 smoothly and uninterruptedly rotates the path of airflow in inlet duct 10 by 180 degrees. The geometry of the fairing 12 and its role in allowing the inlet to create two inlet entries and flow paths is best shown in FIG. 5, in which is provided a cross sectional view of the present invention in the same position as it's is shown in FIG. 1 and FIG. 4. The cutaway perspective is formed by vertically cutting through the center axis of the cylindrical inlet duct 10 with an imaginary plane, exposing internal shaping and arrangements of the various pieces of structure. In the process, the sectional views of the engine 11, fairing 12, and wing 3 along the centerline are also created. Inlet 10 is symmetrical about the dotted axis line, and has a circular inlet open 14. In FIG. 5, engine 11 is situated inside inlet 10 at the rear end, and is a typical gas turbine engine of the current art. The major components of engine 10 include in sequential order from left to right, a fan 21, a compressor section 22, a combustor 23, turbine 24, and nozzle 17, in the order core engine air passes through them. Additionally, engine 10 also has a cylindrical containment casing 26 enclosing the fan section. Its primary job is to not let an accidentally broken off fan blade escape both itself and inlet duct 10 and possibly damage other critical parts of the airplane, such as the wing and fuselage.

Engine 11 is easily recognizable by those with general knowledge of the subject as a turbofan gas turbine engine, distinguished by having fan 21 at the front. Most of the air accelerated by fan 21 bypasses the engine core and is directly blown rearward to generate most of the airplane's thrust. Only a small amount of the air drawn in by fan goes into the core of the engine 10, where it is pressurized in stages by compressor 22 and then ignited with fuel and vapor in combustor 23 to create a fast moving gas stream to rotate a series of turbine 24, which in turn drives the fan via a shaft that runs back to the front of the engine. The type of gas turbine engine that could be used with the fairing and inlet system is not a limiting feature of the present invention, which is focused mainly on providing a dual opening inlet for preventing foreign debris ingestion and providing certain aerodynamic advantages. The engine 10 could easily have been described as a traditional non-bypass turbojet engine without departing from the essence of the invention.

Engine 11, which includes fan 21, compressor section 22, combustor 23, turbine 24, nozzle 17, and casing 26, preferably is placed as far rearward in the inlet 10 as possible but still with most of its components shielded by inlet 10, with only the exit nozzle 17 possibly extending out from the rear opening of inlet, as shown in FIG. 5 and FIG. 4. However, the nozzle 17 may also be housed completely inside inlet duct 10 without deviating from the spirit of the invention. According to the representative embodiment, the engine 11 and the inlet 10 are coaxially arranged along the same line about which the fairing 12 rotates to close one half of the inlet opening 14. It would be beneficial to require the inlet duct 10 be longer than the length of the engine unit 11. The approximate difference by which the length of inlet 10 exceeds that of the engine unit 11 is roughly how far it is between inlet opening 14 and the front most extreme point of engine 11, typically the fan 21's spinner cone 25. The cylindrical inlet duct 10 exhibits visible tapering of its diameter towards the exit, between its opening 14 and where it meets with the engine 11's casing 26. Thus, the diameter of the inlet 10 gradually decreases moving from the inlet opening 14 towards the rear, and eventually equals to the diameter of the fan casing 26. As depicted FIG. 5, rotatable fairing 12 is axially attached into the wing 3's structure and has been rotated to assume a position above wing 3's plane, covering the top half of inlet 10's circular opening 14 while leaving the bottom half open for air to be ingested. Fairing member 12 has a generally elongated shape and can be characterized as having an external portion forward of inlet opening 14, and an internal portion behind inlet opening 14. The external portion of faring 12 is in reality composed of two geometric shapes, one being in the dimension of the wing where the aperture exists and the other being the half-cone structure covering one half of the circular inlet opening 14, as shown in FIG. 1. The external portion of faring 12 has to block half of the inlet opening 14 and at the same time the wing aperture BCDE to ensure that air from only one side of the wing 3's surface enters the engine inlet 10.

In FIG. 5, fairing 12 has been rotated to be above the wing 3's horizontal plane. When faring 12 uses such a configuration, air flowing above wing 3 smoothly slopes up along the curvature of the external portion of fairing 12 and then travels over the top of the inlet 10 before rejoining the atmosphere. The external portion of the fairing 12 provides airflow above the wing a seamless transition from the top surface of the wing 3 to the external surface of inlet 10 above wing 3. By contrast, air below wing 3 enters inlet 10 through the bottom half of inlet 10's opening 14 and then flows smoothly to engine 11 through a channel that is bounded partially by inlet 10's internal surface and partially by the surface of fairing 12's internal portion. The channel that carries air to the engine gradually transitions from a semi-circular shape at the opening 14 of inlet 10 to a full circular dimension just ahead of engine 10. Clearly, besides providing half closure of the inlet 10 and full closure of aperture BCDE, the other main job of fairing 12 is to ensure the smooth flow of air both inside and outside of inlet 10. When a plane is at cruise altitude, faring 12 helps shield noise generated by engine 10's fan 12 from passengers in airplane's cabin, which is situated above wing 3.

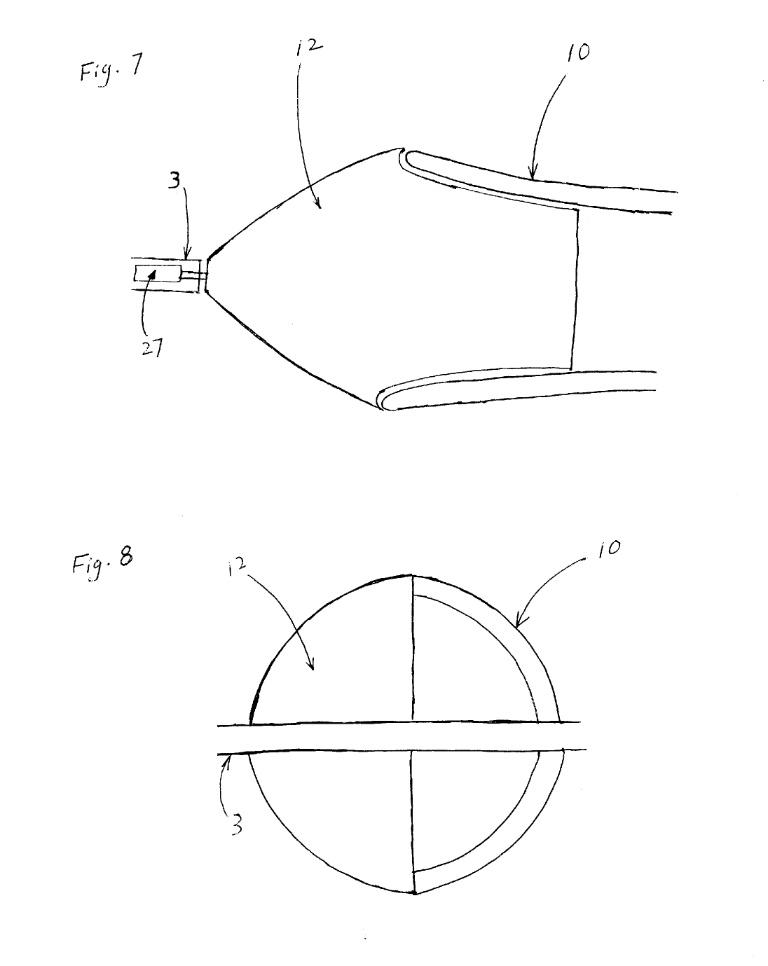

In FIG. 6 shows the other possible position of fairing 12, which has been rotated to be below wing 3's plane. In this configuration, air flowing below wing 3 smoothly slopes down along the curved profile of the external portion of fairing 12 and then continues along the surface of inlet 10 below wing 3 before rejoining the free stream airflow. The external portion of fairing 12 provides airflow below the wing a seamless transition from the bottom surface of wing 3 to the external surface of inlet 10 below wing 3. At the same time, air above wing 3 enters inlet 10 through the top half of inlet 10's opening 14 and then flows smoothly to engine 11 within a channel that is bounded partially by inlet's 10's internal surface and partially by the surface of fairing 12's internal portion. Such mode can be used during low altitude portions of the flight such as approach and takeoff for environmental considerations, because the engine is usually running at relatively high thrust levels and the wing and fairing 12 helps block engine fan noise from disturbing residential areas on the ground. Since engine inlet and fairing are concentrically arranged about a common axis, FIG. 6 is simply FIG. 5 flipped over horizontally.

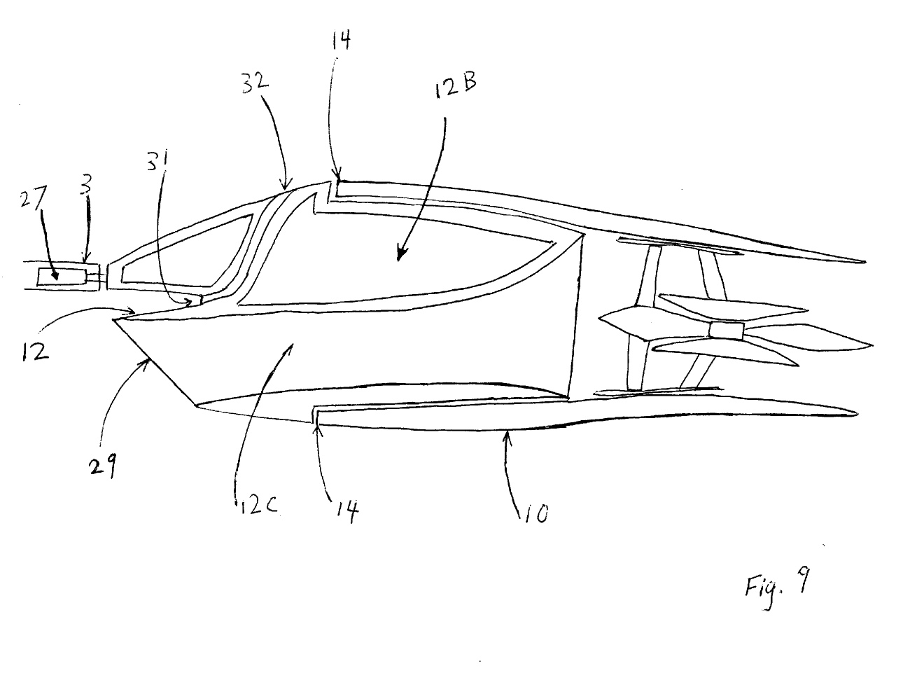

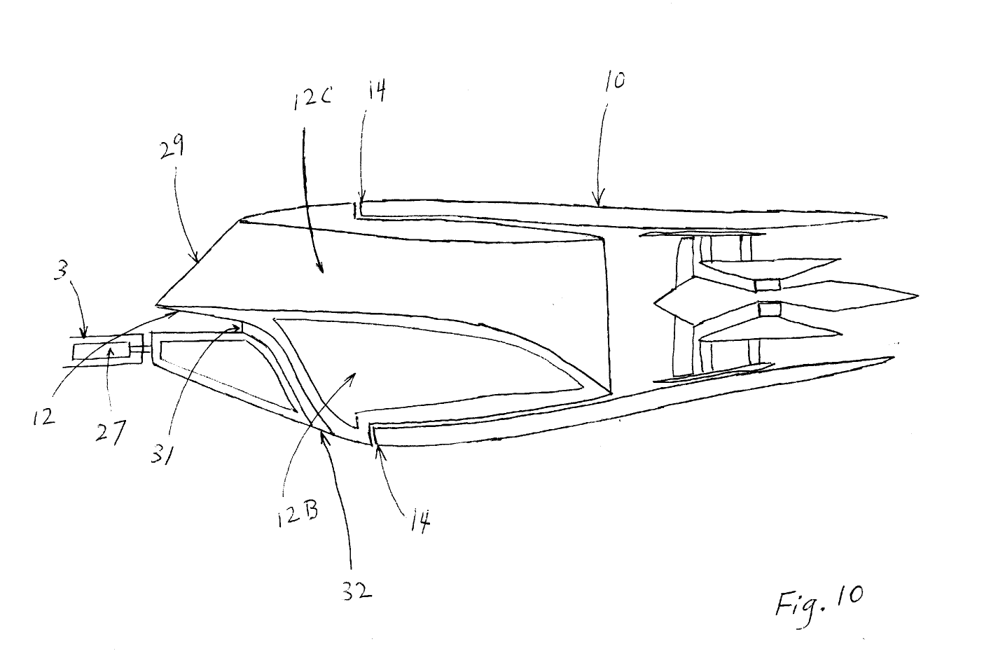

The rotational force needed to produce the rotational movement of the fairing member 12 between the two states of operation, as depicted in FIG. 5 and FIG. 6, originates from an actuator 27 positioned axially forward of the fairing 12 and within wing 3's structure. The actuator 27 is simplistically diagrammed as a box for the sake of generality, since various designs for actuators exist in the known art. Actuator 27 is linked with fairing 12 by a short connecting shaft 28. In operation, rotary motion generated by actuator 27 is carried to the fairing 12 by the connecting shaft 28 and in turn rotates fairing 12 about its axis. When fairing 12 rotates away from its current position, whether it's above the wing or below the wing, the side of the inlet that was in the open state will slowly close while the side previously occupied by fairing 12 will slowly open. The size of the two semi-circle inlet openings either shrinks or increases but at the same angular area rate, until one side is fully open and the other side is fully closed. It should also be readily apparent that at the halfway point during the fairing 12's rotation from one of the positional state to the other, roughly half of the top semi-circle inlet opening and half of the bottom semi-circle inlet opening are obstructed by the fairing, while both the top and bottom half of the inlet have half of its inlet area open to ingest air. The side view of the inlet fairing system in FIG. 7 and the frontal view of the same situation in FIG. 8 depict when the fairing is exactly halfway between its two operational states. At any moment during the fairing's rotation, the amount of inlet opening is guaranteed to be a combination of a portion of the top inlet opening and a portion of the bottom inlet opening and its total area is roughly the same as the fully opened top or bottom inlet opening. Consequently, even if the fairing accidentally stops rotating during transition from one state to the other, air will still be able to flow into the inlet through a sectorial combination of the top and bottom inlet opening.

A second embodiment of the present invention is pictured in FIG. 7 in a sectional view, in which the rotatable fairing 12B is coalesced with an additional rotatable inlet 12C to form a single rotatable fairing-inlet combination 12 that rotates together and is partially supported by fixed inlet 10. A gas turbine engine 11 is situated inside fixed inlet 10 at the rear end, and is again a conventional gas turbine engine. The major components of gas turbine engine 10 include in sequential order from left to right, a fan 21, a compressor section 22, combustor 23 and turbine 24 and nozzle 17, listed in the order the core engine air passes through them. In addition, engine 10 also has a cylindrical containment casing enclosing the major components. Its primary job is to not let an accidentally broken off fan blade escape both itself and fixed inlet duct 10 and damage other critical parts of the airplane, such as the wing and fuselage.

Fixed inlet 10 has a cylindrical shape and is arranged with half of its volume above the wing 3's plane and the other half below the wing 3's plane. Fixed inlet 10 is also substantially longer than the engine 10 because of its need to contain the elongated shape of the fairing-inlet structural member 12. The rotatable fairing-inlet structural member 12 is axially attached into wing 3's structure and is composed of a fairing 12B and an inlet 12C. As shown in FIG. 7, fairing 12B has a generally elongated shape and can be characterized as having an external portion forward of fixed inlet rim 14, and an internal portion behind it. Furthermore, the external portion of faring 12B is a combination of two geometric shapes, one being in the dimension of the wing aperture forward of the fixed inlet 10 and the other being the half-cone structure covering one half of the fixed inlet 10's circular opening. The rotatable inlet 12C then represents the other portion of the fairing-inlet 12 and is mated side-by-side generally along the length of rotatable fairing 12B. Part of the rotatable inlet 12B is on the outside of the fixed inlet 10 and part of it is on the inside of fixed inlet 10. Thus, the fairing-inlet member 12 has a portion forward of the fixed inlet 10's opening 14 and a portion inside fixed inlet 10.

The portion of the fairing-inlet inside the fixed inlet 10 is shaped to match with the contour of the fixed inlet 10's internal surface. Outside, the fairing-inlet 12 fits seamlessly along the cylindrical rim of fixed inlet 10, as well as with the external surface of fixed inlet 10. The rotatable fairing's height is at its maximum where it meets with the rim 14 of fixed inlet 10, and then gradually reduces, with the rotatable inlet 12C occupying more volume, until rotatable fairing-inlet 12 eventually forms a circular rim that matches exactly with the circular cross section of fixed inlet 10 at the point just ahead of the frontal portion of engine 11. The portion of rotatable inlet 12C that is on the outside of the fixed inlet 10 has an opening 29, and no part of the opening 29 is in contact with the fairing. The part of the opening 29 closest to the fairing only merges with the fairing at a position that is a short distance behind the front most extremity of rotatable fairing 12C. In this fashion, a noticeable clearance is created between the outer portion of rotatable inlet 12C and the rotatable fairing 12B. The gap serves the purpose of preventing the thin layer of airflow closest to the wing, formally known in the study of aerodynamics as the boundary layer, from going into the inlet. Thus, the rotatable inlet 12C only receives clean free stream air, which is vital for satisfactory performance of the engine. A large portion of the boundary layer enters channel 30 in rotatable fairing 12B through entrance 31 and leaves through exit 32, joining the airflow over the top of the rotatable fairing 12B.

Additionally, the rotatable fairing-inlet member 12 can also include movable intake ramps, not shown in the drawing, which can be installed along the wall that separates the fairing and the inlet. Movable ramps allow the geometry of the inlet to be varied for different speed regimes to ensure optimal airflow into the core engine.

### CITATION LIST

### Patent Literature

U.S. Pat. No. 8,016,233, Aircraft configuration, Moore, Boren, Marques, Nov. 13, 2011

U.S. Pat. No. 7,900,868, Noise-shielding wing configuration, Sankrithi, Mar. 8, 2011

U.S. Pat. No. D622, 653, Aircraft, Moore, Boren, Marques, Aug. 31, 2010

U.S. Pat. No. 7,051,509, Apparatus for reducing foreign object debris ingestion into aircraft engines, Grimlund, May 30, 2006

U.S. Pat. No. 6,948,854, Integrated and/or modular high-speed aircraft, Nelson, 9/605

U.S. Pat. No. 6,883,751, Apparatus and method for preventing foreign object damage to an aircraft, Koncsek, Apr. 26, 2005

U.S. Pat. No. 6,845,943, Apparatuses and methods for preventing foreign object damage to aircraft engines, Chambers, Cottet, Foutch, Simpson, Jan. 25, 2005

U.S. Pat. No. 6,764,043, Rotatable scarf inlet for an aircraft engine and method for using the same, Sankrithi, Jul. 20, 2004,

U.S. Pat. No. D332, 080, Aircraft, Sandusky Jr., Wolfe, Liu, Fellers, Moore, Jager, Dec. 29, 1992

### Non Patent Literature

Adding New Technology Favored for Sonic Cruiser, Bruce A. Smith, Aug. 3, 2001, Aviation Week & Space Technology

Boeing's Amazing Sonic Cruiser It was supposed to change the way the world flies. Instead the world changed, Alex Taylor III, Dec. 9, 2002, FORTUNE magazine, http://money.cnn.com/magazines/fortune/fortune_archive/2002/12/09/333457/index.htm

Boeing 787 Dreamliner, Guy Norris and Mark Wagner, ISBN 978-0-7603-2815-6

What is claimed is:

1. An inlet system composed of a movable fairing member, a fixed cylindrical inlet duct and a gas turbine engine, arranged in such sequence and integrated into an aircraft's wing.

2. An inlet system as in claim 1 wherein the inlet duct has half of its opening above the wing and the other half below the wing, so that when the fairing is rotated to close the top half of the inlet opening, only air below the wing can flow into the fixed inlet as input to the gas turbine engine while air above the wing flows smoothly over the fairing and around the fixed inlet, and when the fairing is rotated circularly about its axis to close the bottom half of the opening, only the airflow above the wing can smoothly flow into the fixed inlet as input into the gas turbine engine while air below the wing flows smoothly around the fairing and the fixed inlet.

3. An aircraft inlet system wherein the gas turbine is arranged in the rear section of cylindrical duct and is a typical bypass gas turbine engine having sequentially from front to back a fan, a compressor section, a combustor and a turbine.

4. An inlet system as in claim 2 wherein the fairing can either be rotated to assume a position above the wing plane or below the wing plane.

5. An inlet system as in claim 2 wherein the fairing has an external portion outside of front opening of the fixed inlet and an internal portion inside of the front opening of the inlet.

6. An inlet system as in claim 5 wherein the fairing's external portion is further comprised of a rectangular portion that occupies an opening of the same dimension in the wing just ahead of the inlet opening, and blended with the rectangular portion is a faired portion that closes one half of the circular inlet opening.

7. An inlet system as in claim 5 wherein the fairing's internal portion gradually tapers in the direction of the engine until it transitionally develops into a circumferential rim that coincides in curvature with a portion of the internal walls of the fixed inlet duct.

8. An inlet system composed of a rotatably movable fairing-inlet member, a fixed inlet duct and a gas turbine engine arranged and integrated into an aircraft wing in a way that allow allows the fairing-inlet member to be rotated to provide an inlet as lead-in into the main inlet duct either above the wing or below the wing.

9. An inlet system as in claim 8 wherein the main inlet duct is placed into the wing in such a manner that half of the volume is above the wing plane and the other half below the wing plane.

10. An inlet system as in claim 8 wherein the main inlet duct is characterized by a noticeable tapering of volume from the front to the back.

11. An inlet system as in claim 8 wherein the fairing-inlet member has a portion outside of the main inlet duct and a portion that extends into the main inlet duct.

12. An inlet system as in claim 8 wherein the fairing-inlet member is composed of a fairing portion and an inlet portion, which are fused together to form the said member.

13. An inlet system as in claim 8 wherein the fairing-inlet member is rotatable to allow the inlet member to ingest air from above the wing or from below the wing.

14. An inlet system as in claim 12 wherein the inlet portion of the fairing-inlet member has an opening, a duct and an exit that resides within the main inlet duct.

15. An inlet system as in claim 14 wherein the circular exit of the inlet portion of the fairing-inlet member coincides circumferentially with the main inlet duct.

16. An inlet system as in claim 12 wherein a gap exists between the fairing-inlet's inlet's frontal portion and the fairing, followed by a channel to carry boundary layer air through the fairing's interior and ultimately out to the fairing's exterior.

17. An inlet system as in claim 12 where the exterior of the fairing-inlet has a notch that mates with the main inlet duct to create a smooth surface externally where the fairing-inlet member joins the main inlet duct.
